(19) United States
(12) Patent Application Publication
(10) Pub. No.: US 2013/0268662 A1
(43) Pub. Date: Oct. 10, 2013

(54) HYPERTEXT TRANSFER PROTOCOL HTTP STREAM ASSOCIATION METHOD AND DEVICE

(71) Applicant: HUAWEI TECHNOLOGIES CO., LTD., Shenzhen (CN)

(72) Inventor: Jianhua GUO, Beijing (CN)

(21) Appl. No.: 13/911,736

(22) Filed: Jun. 6, 2013

Related U.S. Application Data
(63) Continuation of application No. PCT/CN2011/081934, filed on Nov. 8, 2011.

(30) Foreign Application Priority Data
Dec. 10, 2010 (CN) 201010601431.5

(51) Int. Cl. H04L 29/08

(52) U.S. Cl. CPC H04L 67/02
USPC 709/224

(57) ABSTRACT

Embodiments of the present invention provide a hypertext transfer protocol HTTP stream association method and device. The method includes: receiving a hypertext transfer protocol request HTTP Get; if the HTTP Get does not include a referer Referer field, storing a request uniform resource locator URL in the HTTP Get to an association record table; and if the HTTP Get includes a Referer field, storing a URL included in the Referer field to the association record table, and searching for a same URL in the association record table and performing association matching. By using the hypertext transfer protocol HTTP stream association method and device provided in the embodiments of the present invention, association matching is performed through a URL on multiple mutually associated streams generated in an HTTP event, thereby implementing accurate control and processing on the HTTP event.

### CROSS-REFERENCE TO RELATED APPLICATION

This application is a continuation of International Application No. PCT/CN2011/081934, filed on Nov. 8, 2011, which claims priority to Chinese Patent Application No. 201010601431.5, filed on Dec. 10, 2010, both of which are hereby incorporated by reference in their entireties.

### TECHNICAL FIELD

The present invention relates to the field of information technologies, and in particular, to a hypertext transfer protocol HTTP stream association method and device.

### BACKGROUND

With the development of Internet technologies and the mobile Internet, a hypertext transfer protocol (HyperText Transfer Protocol; HTTP) is applied widely.

The content borne in HTTP is usually in a hypertext markup language (HTML Hypertext Markup Language; HTML) format, and the HTML includes a hyperlink function, so that multiple mutually associated streams are generated in an HTTP event.

In the prior art, the control and processing on the HTTP event are performed based on a single stream, but multiple mutually associated streams may be generated in one HTTP event. Therefore, accurate control and processing on the HTTP event can hardly be performed in the prior art. For example, HTTP event charging and uniform resource locator (Uniform Resource Locators; URL) statistics are not accurate, and URL filtering is not performed thoroughly.

### SUMMARY

Embodiments of the present invention provide a hypertext transfer protocol HTTP stream association method and device, so as to solve the problem that accurate control and processing on an HTTP event can hardly be performed in the prior art.

An embodiment of the present invention provides a hypertext transfer protocol HTTP stream association method, including:

receiving a hypertext transfer protocol request HTTP Get;

if the HTTP Get does not include a referer Referer field, storing a request uniform resource locator URL in the HTTP Get to an association record table; and

if the HTTP Get includes a Referer field, storing a URL included in the Referer field to the association record table, and searching for a same URL in the association record table and performing association matching.

An embodiment of the present invention further provides a hypertext transfer protocol HTTP stream association device, including:

a receiving module, configured to receive a hypertext transfer protocol request HTTP Get; and

a processing module, configured to: if the HTTP Get received by the receiving module does not include a referer Referer field, store a request uniform resource locator URL in the HTTP Get to an association record table; and if the HTTP Get received by the receiving module includes a Referer field, store a URL included in the Referer field to the association record table, search for a same URL in the association record table and perform association matching.

By using the hypertext transfer protocol HTTP stream association method and device provided in the embodiments of the present invention, association matching is performed through a URL on multiple mutually associated streams generated in an HTTP event, thereby implementing accurate control and processing on the HTTP event.

### BRIEF DESCRIPTION OF DRAWINGS

To describe the technical solutions in the embodiments of the present invention more clearly, the following briefly introduces the accompanying drawings required for describing the embodiments or the prior art. Apparently, the accompanying drawings in the following description show merely some embodiments of the present invention, and persons of ordinary skill in the art may still derive other drawings from these accompanying drawings without creative efforts.

FIG. 1 is a flowchart of a first embodiment of a hypertext transfer protocol HTTP stream association method according to the present invention;

FIG. 2 is a signaling diagram of a second embodiment of a hypertext transfer protocol HTTP stream association method according to the present invention;

FIG. 3 is a schematic structural diagram of an association record table according to an embodiment of the present invention; and

FIG. 4 is a schematic structural diagram of a first embodiment of a hypertext transfer protocol HTTP stream association device according to the present invention.

### DESCRIPTION OF EMBODIMENTS

To make the objectives, technical solutions, and advantages of the embodiments of the present invention more comprehensible, the following clearly describes the technical solutions in the embodiments of the present invention with reference to the accompanying drawings in the embodiments of the present invention. Apparently, the described embodiments are merely a part rather than all of the embodiments of the present invention. All other embodiments obtained by persons of ordinary skill in the art based on the embodiments of the present invention without creative efforts shall fall within the protection scope of the present invention.

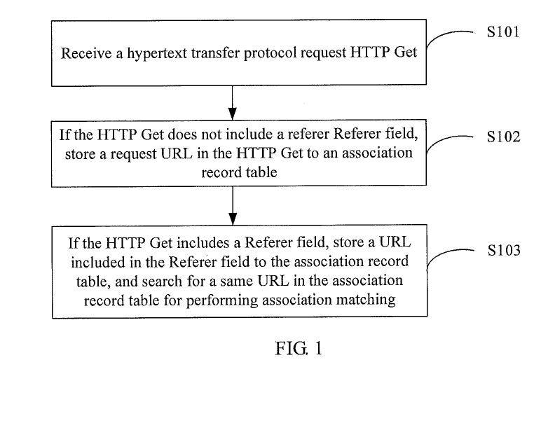

FIG. 1 is a flowchart of a first embodiment of a hypertext transfer protocol HTTP stream association method according to the present invention, and as shown in FIG. 1, the method includes:

S101. receiving a hypertext transfer protocol request HTTP Get;

S102. if the HTTP Get does not include a referer Referer field, storing a request uniform resource locator URL in the HTTP Get to an association record table; and

S103. if the HTTP Get includes a Referer field, storing a URL included in the Referer field to the association record table, and searching for a same URL in the association record table and performing association matching.

In the embodiment of the present invention, a device executing the HTTP stream association method may be a gateway device (Gateway). For example, in various radio 3G networks, the device may be a gateway general packet radio service (General Packet Radio Service; GPRS) support node (Gateway GPRS Support Node; GGSN), a packet data serving node (Packet Data Serving Node; PDSN), or a packet switch gateway (Packet Switch Gateway; PS GW), and the like. The device may also be a relevant gateway device in a fixed network, for example, a broadband access server (Broadband Remote Access Server; BRAS) and the like.

Multiple mutually associated streams may be generated in an HTTP event. For example, when a user accesses a page through a Web client or a browser, because the page may include a hyperlink, the user may establish a connection with multiple servers through the Web client or the browser, where a connection established with each server is referred to as a stream, and multiple streams may be generated when the user accesses a page through the Web client or the browser. In addition, if the page accessed by the user does not include a hyperlink, the user establishes a connection with only one server, and only one single stream is generated.

For ease of description, in the embodiment of the present invention, the stream generated first is referred to as a primary stream, and other stream induced by the primary stream is referred to as a secondary stream.

HTTP Get packets corresponding to the primary stream, the single stream, and the secondary stream each carry a request URL, that is, a URL carried by a request line and a host Host line of the packet. However, the HTTP Get packets corresponding to the primary stream and the single stream do not include the Referer field, where the Referer field is null, and an HTTP Get packet corresponding to the secondary stream includes the Referer field. Because the secondary stream is induced by the primary stream, the Referer field in the packet corresponding to the secondary stream carries the request URL in the primary stream.

In the process in which the user initiates the HTTP Get to a server through the Web client or the browser, the HTTP Get is forwarded by the gateway device. After receiving the HTTP Get, the gateway device determines whether a corresponding stream is the secondary stream by checking whether the Referer field in the HTTP Get is null. If the HTTP Get includes the Referer field, the corresponding stream is the secondary stream; but if HTTP Get does not include the Referer field, the corresponding stream may be the primary stream, and may also be the single stream.

When receiving the HTTP Get packet, the gateway device may store the URL carried in the packet to the association record table, and perform association matching of the primary stream and the secondary stream through URLs of the streams.

Specifically, if the HTTP Get received by the gateway device does not include the Referer field, the corresponding stream may be the primary stream, and may also be the single stream, and the gateway device stores the URL carried in the request line and the Host line to the association record table. If the HTTP Get received by the gateway device includes the Referer field, the corresponding stream is the secondary stream, and the gateway device stores the URL carried in the Referer field to the association record table. The primary stream is the stream generated first, and therefore, when the gateway device stores the URL of the Referer field in the packet corresponding to the secondary stream, a request URL in the packet corresponding to the primary stream inducing the secondary stream is already stored in the association record table. The URL of the Referer field in the packet corresponding to the secondary stream is the same as the request URL in the packet corresponding to the primary stream inducing the secondary stream, and therefore, the gateway device may perform association matching, that is, when storing the URL of the Referer field in the packet corresponding to the secondary stream, the gateway device may search for the same URL in the association record table and perform association matching for the two.

It should be noted that, in many scenarios, and in one HTTP event, one primary stream may induce multiple secondary streams. Therefore, when the gateway device stores the URL of the Referer field in the packet corresponding to the secondary stream, the URL of the Referer field in the packet corresponding to another secondary stream induced by the primary stream may be already stored in the association record table. Therefore, when searching the association record table for association matching, the gateway device may find multiple same URLs. In this case, the gateway device may perform association matching on the URLs together, so as to display all the associated streams generated in one HTTP event in the association record table.

The gateway device may perform association matching in multiple manners, for example, through index table establishment or record identification or in other manners.

The hypertext transfer protocol HTTP stream association method provided in the embodiment of the present invention may be applied to multiple scenarios. For example, when charging is performed for the HTTP event, with the hypertext transfer protocol HTTP stream association method provided in the embodiment of the present invention, the primary stream and a relevant secondary stream can be recognized from the event, thereby improving charging accuracy. During the process of making URL statistics, each associated association information may be included in HTTP statistic information, so that statistic information carrying access hierarchy can be provided; and when URL filtering needs to performed on HTTP access, accurate filtering may be performed on a specific URL through the association between multiple streams, so as to filter out the secondary stream when the primary stream is filtered out.

By using the hypertext transfer protocol HTTP stream association method provided in the embodiment of the present invention, association matching is performed through a URL on multiple mutually associated streams generated in an HTTP event, thereby implementing accurate control and processing on the HTTP event.

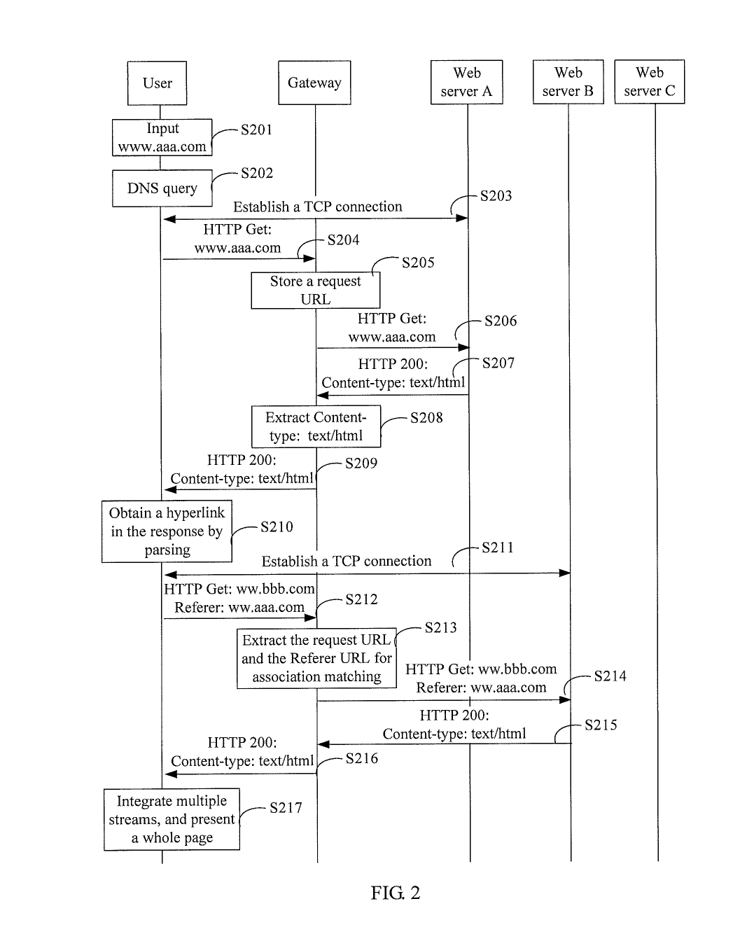

FIG. 2 is a signaling diagram of a second embodiment of a hypertext transfer protocol HTTP stream association method according to the present invention. As shown in FIG. 2, in this embodiment, an HTTP event that the user browses a Web page is taken as an example to describe in detail the HTTP stream association method provided in the present invention, but is not regarded as a limitation on the present invention. The HTTP stream association method provided in the present invention is also applied to multiple application scenarios.

The method includes the following:

S201. A user inputs www.aaa.com at a Web client or a browser.

S202. The browser of the user first obtains an Internet protocol (Internet Protocol; IP) address corresponding to www.aaa.com through a domain name system (Domain Name System; DNS) or a local DNS cache.

S203. The browser and a Web server (Server) A corresponding to the IP address establish a transmission control protocol (Transmission Control Protocol; TCP) connection, that is, generate a stream.

The stream generated in S203 is the stream first generated in the HTTP event, that is, a primary stream.

S204. The browser of the user sends an HTTP Get to the Web server A over the primary stream.

The HTTP Get is sent over the primary stream, and therefore, according to an HTTP protocol, the request does not include a Referer field, and a request URL of a packet, that is a URL of a request line and a Host field of the packet is www.aaa.com.

S205. A gateway receives the HTTP Get, and recognizes that the request does not include the Referer field, and then the gateway extracts the request URL www.aaa.com from the request line and the Host field of the HTTP Get packet and stores it in an association record table.

Because the request does not include the Referer field, the gateway may preliminarily determine that the stream corresponding to the request is not a secondary stream, but may be the primary stream or a single stream.

Further, if the stream corresponding to the HTTP Get is the primary stream, a suffix of a file name of the request is html, php, asp, aspx, shtml or shtm, and the HTTP response corresponding to the request may include a hyperlink. If the stream corresponding to the HTTP Get is the single stream, the suffix of the file name of the request is not the suffix listed in the foregoing, and the HTTP response corresponding to the request does not include a hyperlink. Therefore, the gateway may determine the condition of the single stream accordingly, and delete the request URL in the HTTP Get from the association record table.

Alternatively, if the stream corresponding to the HTTP Get is the single stream, there is no other stream in association matching with the single stream, and according to this, if association matching is not performed within a set time on the URL stored in the association record table, the gateway may delete the URL on which the association matching is not performed.

The gateway may delete the URL record corresponding to the single stream stored in the association record table in the foregoing manners, thereby saving the storage space of the gateway.

S206. The gateway forwards the HTTP Get to the Web server A.

S207. The Web server A returns a response HTTP 200 over the primary stream.

The HTTP 200 is the HTTP response corresponding to the HTTP Get, and a Content-type field of the response packet is: text/html, that is, context borne in the HTTP 200 packet may include a hyperlink, for example, links to resources of multiple sites such as www.bbb.com

S208. The gateway knows that a content-type in the HTTP response is text/html by parsing.

S209. The gateway forwards the HTTP 200 response to the browser of the user.

S210. The browser of the user obtains a hyperlink in the HTTP 200 by parsing.

S211. The browser of the user obtains a hyperlink www.bbb.com/b.jpg by parsing, and establishes a TCP connection automatically with a Web server B corresponding to www.bbb.com according to the HTML protocol, that is, generates a secondary stream.

S212. The browser of the user sends an HTTP Get over the secondary stream, where a URL of the request line and the Host field in the request packet is www.bbb.com/b.jpg, and the URL in the Referer field is www.aaa.com, that is, the same as the request URL of the HTTP Get sent over the primary stream.

S213. The gateway receives the HTTP Get over the secondary stream, and recognizes that the request includes the Referer field.

Because the request includes the Referer field, the gateway recognizes that the stream is the secondary stream, and the gateway stores the request URL www.bbb.com/b.jpg of the request and www.aaa.com stored in the Referer field to the association record table, and identifies the stream corresponding thereto as the secondary stream. The gateway may search for a same URL in the association record table and perform association matching. Because the request URL www.aaa.com corresponding to the primary stream is already stored in the association record table, the gateway can find the request URL corresponding to the primary stream, and mark the stream corresponding thereto as the primary stream.

It should be noted that, if the gateway recognizes that the HTTP Get includes the Referer field, the gateway may recognize that the stream corresponding to the request is the secondary stream. If the HTTP response corresponding to the HTTP Get includes the hyperlink, the gateway may further determine that the corresponding stream is the secondary stream. The feature that the HTTP response corresponding to the HTTP Get includes a hyperlink may assist the gateway to determine that the corresponding stream is the secondary stream.

In S213, the gateway completes association matching between the secondary stream and the primary stream.

S214. The gateway forwards the HTTP Get to the Web server B.

S215. The Web server B responds with a response of HT IP 200.

S216. The gateway forwards the HTTP 200 response of the Web server B to the browser of the user.

The browser detects whether there is other hyperlink requiring a secondary stream to be established. If the response also includes other hyperlink, a TCP connection is established between the browser and a server corresponding to another hyperlink, and another secondary stream is generated, that is, steps S211 to S216 are performed.

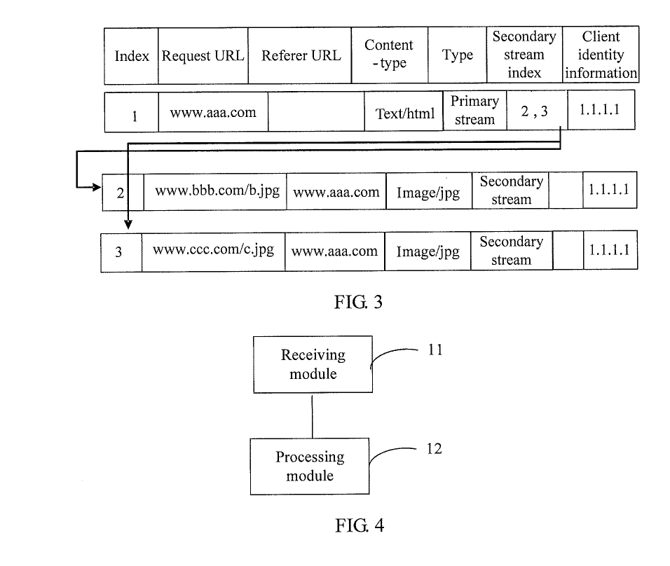

Finally, a mutual association between multiple streams can be identified in the association record table, and the matching association may be established through an index, referring to FIG. 3. Certainly the matching association between the multiple streams may also be established in other feasible manners.

S217. After integrating content obtained from multiple associated streams, the browser presents a complete Web page to the user.

The user browsing event is completed.

In addition, it should be noted that, different users may browse a same Web page through the browser at the same time. In this case, in order to accurately associate the multiple streams generated by the user, the client identity information may be marked on each URL recorded in the association record table, where the client identity information is used to uniquely identify a client sending the HTTP Get, and may be identification information such as an IP address, a port number, or a media access control (Media Access Control; MAC) address.

In this embodiment, only a scenario where the user browses a Web page is taken as an example to describe the HTTP stream association method provided in the present invention, and the HTTP stream association method provided in the embodiment of the present invention may also be applied to scenarios such as the HTTP event charging, URL statistics, or URL filtering, which is not enumerated herein.

Persons of ordinary skill in the art may understand that all or a part of the processes of the methods in the embodiments may be implemented by a computer program instructing relevant hardware. The program may be stored in a computer readable storage medium. When the program is run, the processes of the methods in the embodiments are performed. The storage medium may be a magnetic disk, an optical disk, a Read-Only Memory (Read-Only Memory, ROM), or a Random Access Memory (Random Access Memory, RAM).

FIG. 4 is a schematic structural diagram of a first embodiment of a hypertext transfer protocol HTTP stream association device according to the present invention. As shown in FIG. 4, the device includes a receiving module 11 and a processing module 12, where:

the receiving module 11 is configured to receive an HTTP Get; and

the processing module 12 is configured to: if the HTTP Get received by the receiving module 11 does not include a Referer field, store a request uniform resource locator URL in the HTTP Get to an association record table; and if the HTTP Get received by the receiving module 11 includes a Referer field, store a URL included in the Referer field to the association record table, search for a same URL in the association record table and perform association matching.

On the basis of the foregoing embodiment,

the receiving module 11 may further be configured to receive an HTTP response corresponding to the HTTP Get; and

the processing module 12 may further be configured to: if the HTTP response received by the receiving module 11 includes a hyperlink, mark a stream corresponding to the URL in the Referer field in the HTTP Get stored in the association record table as a secondary stream, and mark a stream corresponding to the URL in association matching with the URL in the Referer field as a primary stream.

Further, the processing module 12 is further configured to mark client identity information on the URL or URLs stored in the association record table, where the client identity information is used to uniquely identify a client sending the HTTP Get.

Further, the processing module 12 is further configured to: if the HTTP response corresponding to the HTTP Get and received by the receiving module 11 does not include a hyperlink, delete the request URL in the HTTP Get from the association record table.

Further, the processing module 12 is further configured to: if association matching is not performed within a set time on the URL stored in the association record table, delete the URL on which the association matching is not performed.

The hypertext transfer protocol HTTP stream association device provided in this embodiment performs association matching through a URL on multiple mutually associated streams generated in an HTTP event, thereby implementing accurate control and processing on the HTTP event.

The hypertext transfer protocol HTTP stream association device provided in this embodiment is a functional device implementing the HTTP stream association method provided in the embodiment of the present invention, and the device may be a gateway device (Gateway), for example, a GGSN, PDSN, or PS GW, and may also be a relevant gateway device in the fixed network, for example, a BRAS. The specific process in which the HTTP stream association device provided in this embodiment executes the HTTP stream association method corresponds to the foregoing method embodiment. For details, reference may be made to the foregoing method embodiment, which is not described again herein.

Finally, it should be noted that the foregoing embodiments are merely provided for describing the technical solutions of the present invention, but not intended to limit the present invention. It should be understood by persons of ordinary skill in the art that although the present invention has been described in detail with reference to the foregoing embodiments, modifications can be made to the technical solutions described in the foregoing embodiments, or equivalent replacements can be made to some technical features in the technical solutions, as long as such modifications or replacements do not cause the essence of corresponding technical solutions to depart from the spirit and scope of the present invention.

What is claimed is:

1. A hypertext transfer protocol (HTTP) stream association method, comprising:
receiving a first HTTP Get over a first stream, wherein the first HTTP Get does not comprise a Referer field, and the first HTTP Get comprises a first request URL;
receiving a second HTTP Get over a second stream, wherein the second HTTP Get comprises a Referer field, the Referer field of the second HTTP Get comprises the first request URL, and the second HTTP Get comprises a second request URL; and
according to the first request URL comprised in the Referer field of the second HTTP Get, associating the first stream and the second stream.

2. The method according to claim 1, further comprising:
marking the first stream as a primary stream, and marking the second stream as a secondary stream.

3. The method according to claim 1, further comprising:
marking client identity information on the first stream and the second stream, wherein the client identity information is used to uniquely identify a client sending the first HTTP Get and the second HTTP Get.

4. The method according to claim 1, wherein before receiving the second HTTP Get, the method further comprises:
receiving a HTTP response corresponding to the first HTTP Get, wherein the HTTP response comprises a hyperlink, wherein the second request URL is the same as the hyperlink.

5. The method according to claim 1, wherein the first request URL is stored in a first record corresponding to the first stream in an association record table, and the second request URL and the first request URL are stored in a second record corresponding to the second stream in the association record table, wherein the associating the first stream and the second stream comprises:
associating the first record and the second record.

6. The method according to claim 5, further comprising:
marking the first stream as a primary stream in the first record, and marking the second stream as a secondary stream in the second record.

7. The method according to claim 5, further comprising:
marking client identity information on the first record and the second record.

8. An apparatus configured to perform hypertext transfer protocol (HTTP) stream association, comprising:
a receiving module, configured to receive a first HTTP Get over a first stream, wherein the first HTTP Get does not comprise a Referer field, and the first HTTP Get comprises a first request URL, and configured to receive a second HTTP Get over a second stream, wherein the second HTTP Get comprises a Referer field, the Referer field of the second HTTP Get comprises the first request URL, and the second HTTP Get comprises a second request URL; and
a processing module, configured to, according to the first request URL comprised in the second HTTP Get, associate the first stream corresponding to the first request URL and the second stream corresponding to the second request URL.

9. The apparatus according to claim 8, wherein the processing module is configured to mark the first stream as a primary stream and mark the second stream as a secondary stream.

10. The apparatus according to claim 8, wherein the processing module is configured to mark client identity information on the first stream and the second stream, wherein the client identity information is used to uniquely identify a client sending the first HTTP Get and the second HTTP Get.

11. The apparatus according to claim 8, wherein the receiving module is configured to, before receiving the second HTTP Get, receive a HTTP response corresponding to the first HTTP Get, wherein the HTTP response comprises a hyperlink, wherein the second request URL is the same as the hyperlink.

12. The apparatus according to claim 8, wherein the apparatus comprises a storing module, wherein the storing module is configured to store the first request URL in a first record corresponding to the first stream in an association record table, and to store the second request URL and the first request URL in a second record corresponding to the second stream in the association record table, wherein the association module is configured to associate the first record and the second record according to the first request URL comprised in the second HTTP Get.

13. The apparatus according to claim 12, wherein the processing module is configured to mark the first stream as a primary stream in the first record and mark the second stream as a secondary stream in the second record.

14. The apparatus according to claim 13, wherein the processing module is configured to mark client identity information on the first record and the second record.

15. The apparatus according to claim 8, wherein the apparatus is a gateway general packet radio service (GPRS) support node (GGSN), a packet data serving node (PDSN), a packet switch gateway (PS GW), or a broadband access server (BRAS).
